(19) United States
(12) Patent Application Publication
(10) Pub. No.: US 2025/0280812 A1
(43) Pub. Date: Sep. 11, 2025

(54) Waterproof Bait Box

(71) Applicant: Shenzhen Bosaidong Technology Co., Ltd., Shenzhen (CN)

(72) Inventors: Dan Xie, Shenzhen (CN); Tianshi Cui, Shenzhen (CN)

(21) Appl. No.: 18/663,045

(22) Filed: May 13, 2024

(30) Foreign Application Priority Data
Mar. 5, 2024 (CN) 202420449346.9

(51) Int. Cl. A01K 97/06

(52) U.S. Cl. CPC A01K 97/06

(57) ABSTRACT

The present application discloses a waterproof bait box, including: a box body provided with an opening at a top; a cover body rotatably connected with one side of the box body and covering the opening; and a locking piece including a connecting piece and a locking plate, wherein one side of the connecting piece is rotatably connected with one side of the locking plate; the other side of the connecting piece is rotatably connected with the box body; the other side of the locking plate is capable of being connected with the cover body in a buckling manner; and when the other side of the locking plate is connected with the cover body in the buckling manner, one side of the locking plate and one side of the connecting piece can rotate towards the box body and be buckled to lock the box body and the cover body.

### CROSS REFERENCES TO RELATED APPLICATION

The present application claims the benefit of Chinese Patent Application No. 202420449346.9 filed on Mar. 5, 2024, the contents of which are incorporated herein by reference in their entirety.

### TECHNICAL FIELD

The present application relates to the technical field of fishing bait boxes, and in particular to a waterproof bait box.

### BACKGROUND ART

At present, with the improvement in living standards of people, fishing has become one of the ways for people to have fun in leisure time. The bait box is one of common tools for people to fish. People usually put fishing bait into the bait box to store and protect the fishing bait.

However, the bait box in the prior art is poor in sealing performance, so that moisture easily penetrates into the bait box to cause deterioration of the fishing bait due to exposure to the moisture.

### SUMMARY OF THE INVENTION

A purpose of the present application is to provide a waterproof bait box, to solve the problem that the bait box in the prior art is poor in sealing performance.

To solve the above technical problem, the purpose of the present application is achieved by the following technical solution: providing a waterproof bait box, which includes:
a box body provided with an opening at a top,
a cover body rotatably connected with one side of the box body and covering the opening, and
a locking piece including a connecting piece and a locking plate, wherein one side of the connecting piece is rotatably connected with one side of the locking plate; the other side of the connecting piece is rotatably connected with the box body; the other side of the locking plate is capable of being connected with the cover body in a buckling manner;
when the other side of the locking plate is connected with the cover body in the buckling manner, one side of the locking plate and one side of the connecting piece can rotate towards the box body and be buckled to lock the box body and the cover body.

Further, an abutting part is arranged at one side of the locking plate; and one side of the connecting piece is rotatably connected with the abutting part. When one side of the locking plate and one side of the connecting piece rotate towards the box body and are buckled, the abutting part is capable of being abutted against the box body, so that a space is formed between the locking plate and the box body.

Further, the connecting piece includes a first connecting rod and a second connecting rod, wherein the first connecting rod is connected with the second connecting rod in a radial direction; the first connecting rod is rotatably connected with the locking plate; and the second connecting rod is rotatably connected with the box body.

Further, a mounting part is arranged on the box body, wherein a through hole is formed in the mounting part; a mounting port is formed in a side wall of the through hole; and the second connecting rod is extruded and assembled in the through hole through the mounting port and is rotatably arranged.

Further, a protruding part is arranged on an inner wall of the through hole; and the second connecting rod is limited in the through hole by the protruding part.

Further, a first convex strip is arranged at the other side of the locking plate; a corresponding second convex strip is arranged on the cover body; and the locking plate and the cover body are connected with the second convex strip through the first convex strip in the buckling manner.

Further, the side where the first convex strip is buckled with the second convex strip is set as a first inclined surface or a first arc surface; one side of the second convex strip away from the locking plate is set as a second inclined surface opposite to the first inclined surface or a second arc surface opposite to the first arc surface; and the first convex strip and the second convex strip are capable of being buckled with each other through the first inclined surface and the second inclined surface or the first arc surface and the second arc surface.

Further, the waterproof bait box also includes a sealing piece, which is arranged between covering surfaces of the cover body and the box body.

Further, a plurality of partition plates and inserts are arranged inside the box body; mounting slide chutes are correspondingly formed in side walls of the partition plates and the inner wall of the box body, and/or mounting slide chutes are correspondingly formed in side walls of adjacent partition plates; and both sides of the inserts are detachably mounted in the mounting slide chutes, to form a plurality of independent partition slots.

Further, clamping strips are arranged at both sides of the inserts; notches of the mounting slide chutes are gradually enlarged from outside to inside; and the clamping strips are mounted in the mounting slide chutes.

Further, a protruding clamping part is arranged on each clamping strip.

Further, a bottom groove communicated with the mounting slide chutes is further formed at the inner bottom of the box body; a communication part between each mounting slide chute and the bottom groove is set as an arc groove; arc parts adapted to the arc groove are arranged at two side bottoms of the inserts; and the bottoms of the inserts are limited in the bottom groove.

Further, a plurality of air holes distributed at intervals are formed in the inserts.

Further, the waterproof bait box also includes a storage box, wherein both sides of the storage box are detachably mounted in the box body.

Further, the cover body is made of a transparent material.

Further, anti-skid stripes and/or anti-skid pads are arranged at the bottom of the box body.

Further, a scaleplate is arranged on a surface of the cover body.

An embodiment of the present application provides a waterproof bait box, including: a box body provided with an opening at the top, a cover body rotatably connected with one side of the box body and covering the opening, and a locking piece including a connecting piece and a locking plate, wherein one side of the connecting piece is rotatably connected with one side of the locking plate; the other side of the connecting piece is rotatably connected with the box body; the other side of the locking plate is capable of being connected with the cover body in a buckling manner; and when the other side of the locking plate is connected with the cover body in the buckling manner, one side of the locking plate and one side of the connecting piece can rotate towards the box body and be buckled to lock the box body and the cover body. According to the present application, the locking piece can lock the cover body and the box body by arranging the locking piece at the outer side of the bait box, to improve the sealing performance of the cover body and the box body, thereby preventing bait from deterioration due to exposure to moisture entering the box body.

### BRIEF DESCRIPTION OF THE DRAWINGS

To explain technical solutions in embodiments of the present application more clearly, the accompanying drawings needed in the description of the embodiments will be briefly introduced below. Apparently, the accompanying drawings in the following description refer to some embodiments of the present application. Those of ordinary skill in the art can also obtain other accompanying drawings according to these accompanying drawings without creative work.

FIG. 1 is a schematic diagram of an overall structure of a bait box provided by an embodiment of the present application;

FIG. 2 is a schematic diagram of another overall structure of the bait box provided by the embodiment of the present application;

FIG. 3 is a sectional view of the bait box provided by the embodiment of the present application;

FIG. 4 is an enlarged view of A in FIG. 3;

FIG. 5 is another sectional view of the bait box provided by the embodiment of the present application;

FIG. 6 is an enlarged view of B in FIG. 5;

FIG. 7 is a structural schematic diagram of a locking piece provided by the embodiment of the present application;

FIG. 8 is a structural schematic diagram of a box body provided by the embodiment of the present application;

FIG. 9 is an enlarged view of C in FIG. 8;

FIG. 10 is a structural schematic diagram of an insert provided by the embodiment of the present application;

FIG. 11 is a structural schematic diagram of the bottom of the box body provided by the embodiment of the present application;

FIG. 12 is an enlarged view of D in FIG. 11; and

FIG. 13 is a structural schematic diagram of a cover body provided by the embodiment of the present application.

### DESCRIPTION OF LABELS IN THE FIGURES

1. box body; 11. mounting part; 111. through hole; 112. mounting port; 113. protruding part; 12. partition plate; 13. insert; 131. clamping strip; 132. arc part; 133. air hole; 14. mounting slide chute; 15. storage box; 16. anti-skid stripe; 17. bottom groove; 171. arc groove;
2. cover body; 21. second convex strip;
3. locking piece; 31. locking plate; 32. connecting piece; 321. first connecting rod; 322. second connecting rod; 33. first convex strip; and 34. abutting part.

### DETAILED DESCRIPTION OF THE INVENTION

Technical solutions in embodiments of the present application will be described clearly and completely in combination with the accompanying drawings in the embodiments of the present application. Apparently, the described embodiments are partial embodiments of the present application, but not all embodiments. All other embodiments obtained by those of ordinary skill in the art based on the embodiments of the present application without creative work should fall within the protection scope of the present application.

It should be understood that the terms “include” and “contain” when used in the description and the appended claims indicate the presence of the described characteristics, integers, steps, operations, elements and/or components, but do not exclude the presence or addition of one or more other characteristics, integers, steps, operations, elements, components and/or sets thereof. It should also be understood that the terms used in the description of the present application are only intended for describing specific embodiments, rather than limiting the present application. As used in the description of the present application and the appended claims, the terms “a”, “an” and “the” indicating singular forms are intended to include plural forms unless the context clearly indicates otherwise.

It should be further understood that the term “and/or” used in the description of the present application and the appended claims refers to any combination and all possible combinations of one or more of the associated listed items, and includes these combinations.

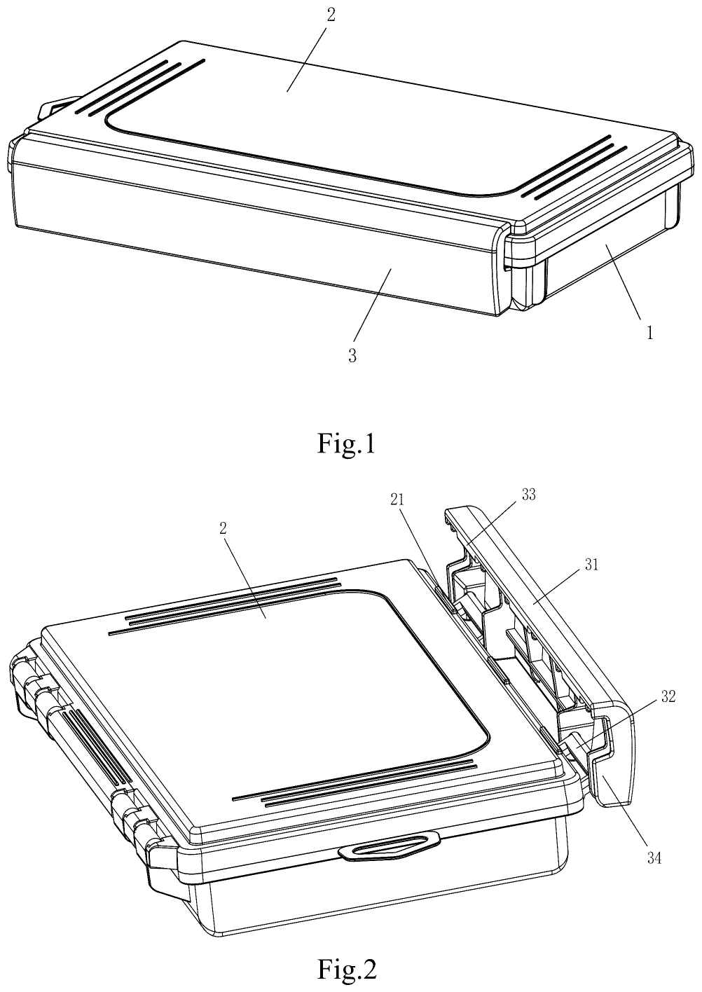

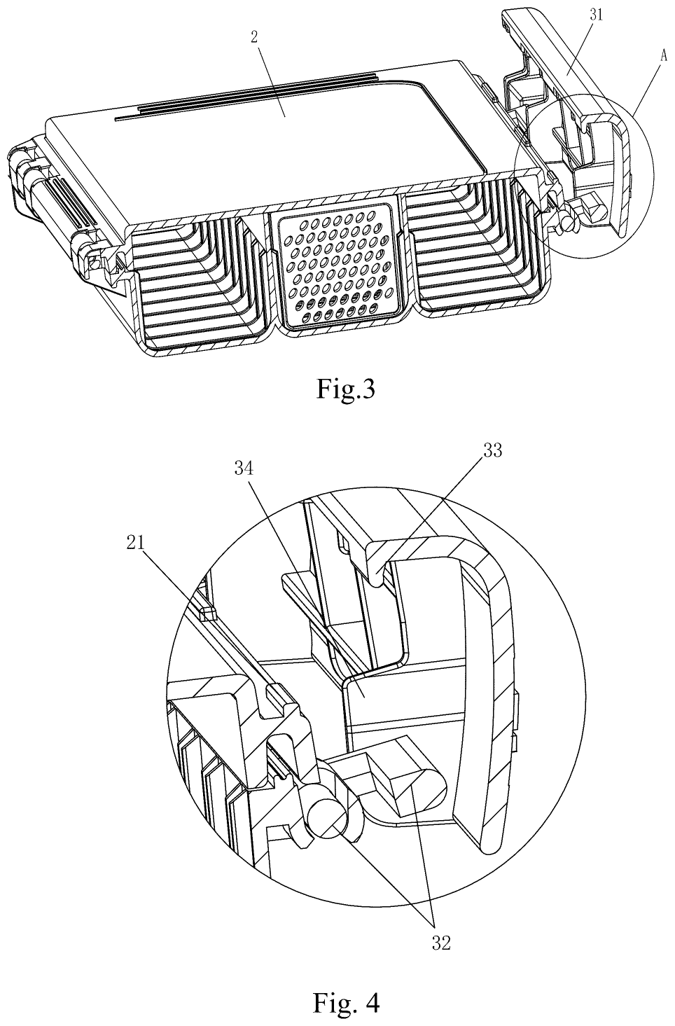

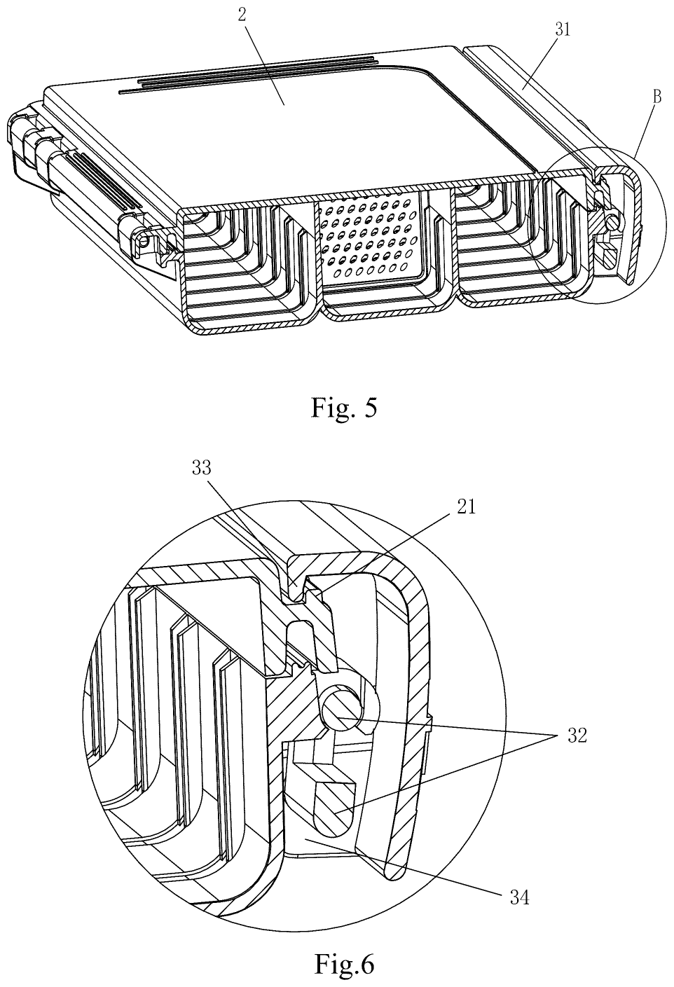

Referring to FIGS. 1-6, an embodiment of the present application provides a waterproof bait box, which includes: a box body 1 provided with an opening at the top, a cover body 2 rotatably connected with one side of the box body 1 and covering the opening, and a locking piece 3 including a connecting piece 32 and a locking plate 31, wherein one side of the connecting piece 32 is rotatably connected with one side of the locking plate 31; the other side of the connecting piece 32 is rotatably connected with the box body 1; the other side of the locking plate 31 is capable of being connected with the cover body 2 in a buckling manner; and when the other side of the locking plate 31 is connected with the cover body 2 in the buckling manner, one side of the locking plate 31 and one side of the connecting piece 32 can rotate towards the box body 1 and be buckled to lock the box body 1 and the cover body 2.

In the present embodiment, the cover body 2 can rotate on the box body 1 to open and close the opening of the box body 1. By arrangement of the locking piece 3, when the cover body 2 closes the opening of the box body 1, the locking piece 3 can lock the cover body 2 on the box body 1 to prevent the cover body 2 from opening the opening of the box body 1, thereby improving the airtightness of the box body 1, benefiting to prevent moisture from entering the box body 1, and further preventing the bait in the box body 1 from deterioration due to exposure to the moisture. Locking processes are specifically shown as follows: firstly, the cover body 2 is initially covered on the opening of the box body 1; then, the other side of the locking plate 31 is first connected with the cover body 2 in a buckling manner; at this time, due to the matching relationship between the locking plate 31 and the connecting piece 32, one side of the locking plate 31 facing the cover body 2 will be resisted by the connecting piece 32; when pressure is applied to fasten one side of the locking plate 31 facing the cover body 2, the applied pressure is transferred from one side of the connecting piece 32 to the other side, so that the other side of the connecting piece 32 drives the box body 1 to abut against the cover body 2, while the other side of the locking plate 31 drives the cover body 2 to abut against the cover body 2; and therefore, the effect of locking the cover body 2 and the box body 1 by the locking piece 3 is improved. It is easy to understand that in the locking processes, the cover body 2 is located above the box body 1, and the other side of the locking plate 31 rotates towards the cover body 2, i.e., the other side of the locking plate 31 rotates upwards; and one side of the locking plate 31 rotates towards the box body 1, i.e., one side of the locking plate 31 rotates downwards.

Unlocking processes are specifically shown as follows: firstly, a force rotating away from the box body 1 is applied from one side of the locking plate 31; at the same time, the other side of the locking plate 31 will be loosely separated from the cover body 2; then, the other side of the locking plate 31 will be rotated away from the cover body 2, so that the restrictions of the locking plate 31 on the cover body 2 and the box body 1 can be removed, and then the cover body 2 can be rotated upward of the box body 1 to open the opening of the box body 1. An abutting part 34 (as shown in FIGS. 2, 4, 6 and 7) is convexly arranged at one side of the locking plate 31; one side of the connecting piece 32 is rotatably connected with the abutting part 34; in the present embodiment, the abutting part 34 is located at an end part of the locking plate 31; and after the locking plate 31 locks the cover body 2 and the box body 1, the abutting part 34 is capable of being abutted against the outer surface of the box body 1, so that a space is formed between the locking plate 31 and the box body 1, then the locking plate 31 can be pulled from the space when the locking plate 31 is unlocked, and the locking plate 31 can be rotated away from the box body 1.

In the present embodiment, a plurality of connecting pieces 32 can be provided, to improve the rotation stability of the locking plate 31. In the present embodiment, two connecting pieces are preferably provided and respectively located at two opposite ends of the locking plate 31.

In the present embodiment, the cover body 2 is detachably connected with a housing, so that the cover body 2 and the housing can be separated in case of damage to the box body 1 or the cover body 2, to replace the box body 1 or the cover body 2 with a new one.

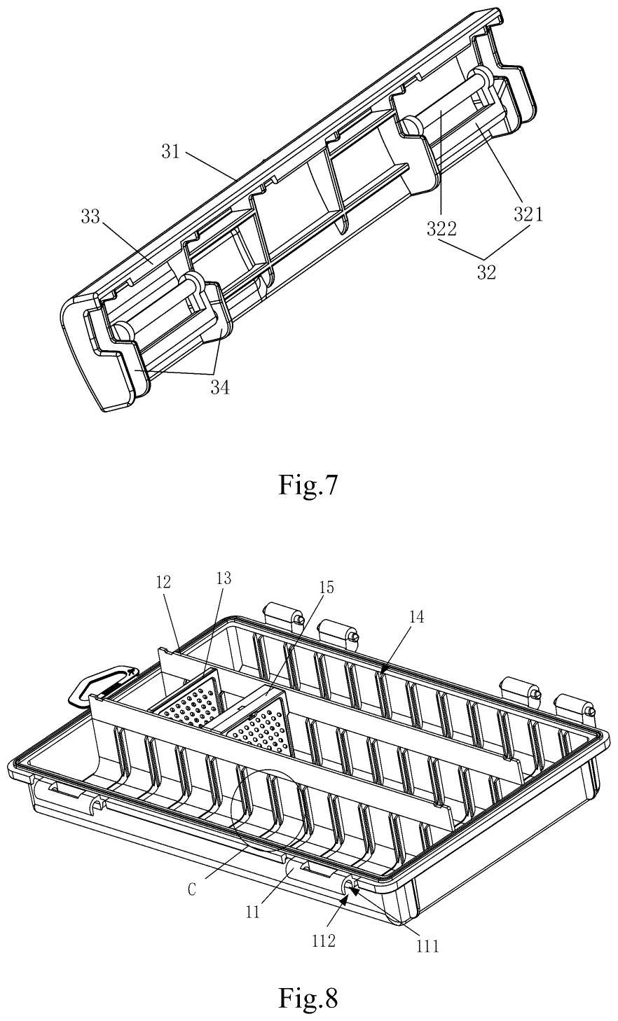

Referring to FIG. 7, in one embodiment, the connecting piece 32 includes a first connecting rod 321 and a second connecting rod 322; the first connecting rod 321 is connected with the second connecting rod 322 in a radial direction; the first connecting rod 321 is rotatably connected with the locking plate 31; and the second connecting rod 322 is rotatably connected with the box body 1.

In the present embodiment, when the locking piece 3 is buckled on the cover body 2 and the box body 1, the locking plate 31 and the first connecting rod 321 are first rotated towards the cover body 2 with the second connecting rod 322 as a rotation axis; then, the locking plate 31 is rotated towards the cover body 2 with the first connecting rod 321 as the rotation axis, so that the locking plate 31 is buckled on the cover body 2; and finally, the locking plate 31 and the first connecting rod 321 are rotated towards the box body 1 with the second connecting rod 322 as the rotation axis, so that the locking plate 31 is capable of being abutted against the box body 1, and then the locking plate 31 can be stably connected with the cover body 2 in the buckling manner.

In the present embodiment, the first connecting rod 321 and the second connecting rod 322 are parallel to each other in an axial direction; both ends of the first connecting rod 321 and both ends of the second connecting rod 322 are connected with each other, i.e., the first connecting rod 321 and the second connecting rod 322 are connected in the radial direction; and there is a certain distance between the first connecting rod 321 and the second connecting rod 322, so that a rotation amplitude of the locking plate 31 can be larger during rotation, thereby improving the convenience that the locking plate 31 is connected with the cover body 2 in the buckling manner.

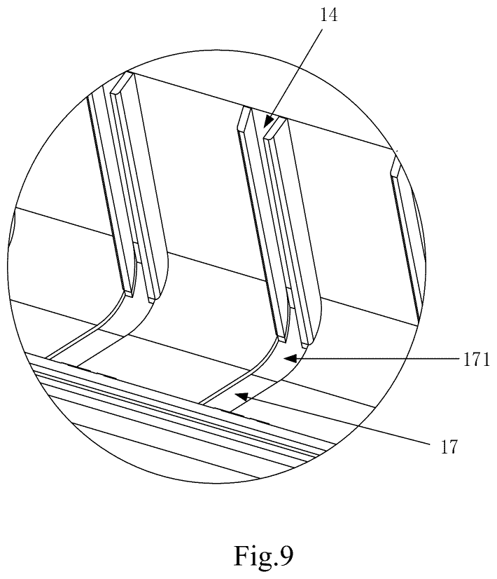

Referring to FIGS. 8, 11 and 12, in one embodiment, a mounting part 11 is arranged on the box body 1; a through hole 111 is formed in the mounting part 11; a mounting port 112 is formed in a side wall of the through hole 111; and the second connecting rod 322 is extruded and assembled in the through hole 111 through the mounting port 112 and is rotatably arranged.

In the present embodiment, the second connecting rod 322 is extruded and assembled in the through hole 111, which is beneficial to improving the convenience of mounting the second connecting rod 322 and the mounting part 11. When the locking piece 3 needs to be disassembled from the box body 1, the second connecting rod 322 can be directly taken out from the through hole 111 by applying external force without a disassembly tool, so that the locking piece 3 can be conveniently and rapidly separated from the box body 1.

The mounting part 11 and/or the second connecting rod 322 is made of plastically deformable materials; and the aperture of the mounting port 112 is smaller than the diameter of the second connecting rod 322.

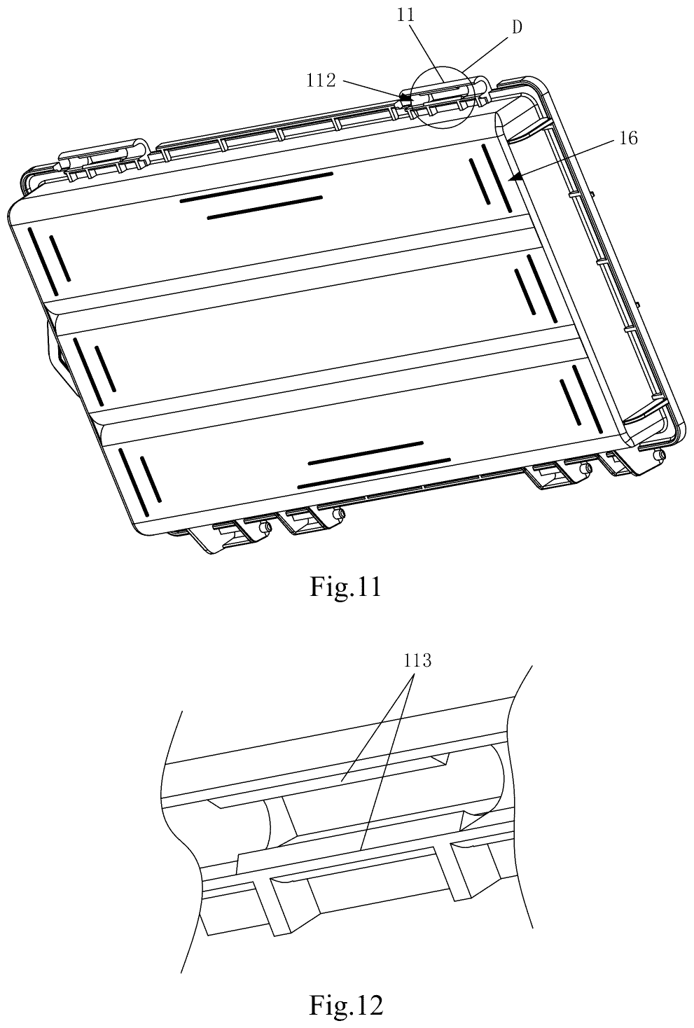

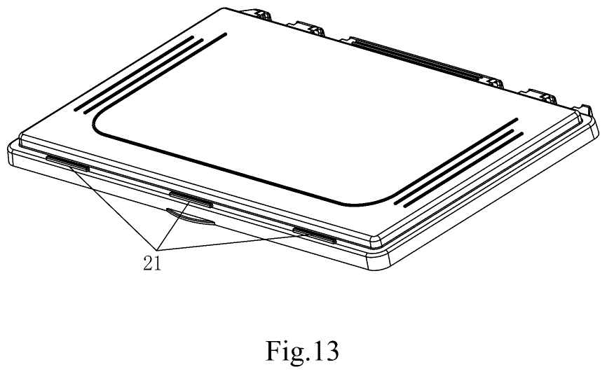

Referring to FIGS. 11 and 12, in a more specific embodiment, a protruding part 13 is arranged on the inner wall of the through hole 111; and the second connecting rod 322 is limited in the through hole 111 by the protruding part 113.

In the present embodiment, the protruding part 113 is provided, to make for improving the stability of the second connecting rod 322 in the through hole 111, thereby avoiding the problem that the second connecting rod 322 falls off the mounting part 11 during rotation.

A plurality of protruding parts 113, preferably two in the present embodiment, can be provided and respectively located on the opposite inner walls of the mounting port 112.

Referring to FIGS. 2-7 and 13, in one embodiment, a first convex strip 33 is arranged at the other side of the locking plate 31; a corresponding second convex strip 21 is arranged on the cover body 2; and the locking plate 31 and the cover body 2 are connected with the second convex strip 21 through the first convex strip 33 in the buckling manner.

In the present embodiment, when the other side of the locking plate 31 rotates towards the cover body 2, the first convex strip 33 is capable of being connected with a side edge of the second convex strip 21 away from the locking plate 31 in the buckling manner; and then one side of the locking plate 31 rotates towards the box body 1 and abuts against the box body 1, so that the locking plate 31 can lock the cover body 2 and the box body 1.

In the present embodiment, when one side of the locking plate 31 rotates away from the box body 1, the first convex strip 33 can be loosely separated from the side edge of the second convex strip 21 away from the locking plate 31; and then the other side of the locking plate 31 rotates away from the cover body 2, to release the locking state of the locking plate 31 on the cover body 2 and the box body 1.

The first convex strip 33 and the second convex strip 21 respectively extend along a length direction of the locking plate 31 and the cover body 2.

More specifically, to improve the stability of buckling connection between the locking plate 31 and the cover body 2, a plurality of first convex strips 33 and second convex strips 21, preferably three in the present embodiment, can be correspondingly provided and respectively arranged on the locking plate 31 and the cover body 2 at intervals.

In one embodiment, the side where each first convex strip 33 is buckled with each second convex strip 21 is set as a first inclined surface or a first arc surface; one side of the second convex strip 21 away from the locking plate 31 is set as a second inclined surface opposite to the first inclined surface or a second arc surface opposite to the first arc surface; and the first convex strip 33 and the second convex strip 21 are capable of being buckled with each other through the first inclined surface and the second inclined surface or the first arc surface and the second arc surface.

In the present embodiment, when each first convex strip 33 is buckled with each second convex strip 21, the first inclined surface and the second inclined surface or the first arc surface and the second arc surface are opposite to each other, so one side of the locking plate 31 can rotate towards the box body 1 again and abut against the box body 1 after the first convex strip 33 abuts against the second convex strip 21, to improve the stability of buckling between the first convex strip 33 and the second convex strip 21.

In one embodiment, the waterproof bait box further includes a sealing piece, which is arranged between covering surfaces of the cover body 2 and the box body 1.

In the present embodiment, the sealing piece is provided, to enhance the sealing effect of the cover body 2 and the box body 1, thereby improving the airtightness of the box body 1, preventing moisture from entering the box body 1, and preventing the bait in the box body 1 from deterioration due to exposure to the moisture. Specifically, the sealing piece can be an annular sealing ring; and the sealing ring can be stuck in a circumferential direction of the cover surface of the cover body 2 or the box body 1, to achieve sealing when the cover body 2 and the box body 1 are covered.

In the present embodiment, the sealing piece is arranged on the cover body 2 as an example. A groove is arranged in the circumferential direction where the cover body 2 and the box body 1 are covered, and the sealing piece is mounted in the groove and is flush with the groove. Furthermore, an abutting strip is convexly arranged in the circumferential direction where the box body 1 and the cover body 2 are covered. When the cover body 2 and the box body 1 are covered, the sealing piece is capable of being abutted against the abutting strip, thereby improving the sealing effect of the cover body 2 and the box body 1.

Referring to FIGS. 8 and 9, in one embodiment, a plurality of partition plates 12 and inserts 13 are arranged inside the box body 1; mounting slide chutes 14 are correspondingly formed in side walls of the partition plates 12 and the inner wall of the box body 1, and/or mounting slide chutes 14 are correspondingly formed in side walls of adjacent partition plates 12; and both sides of the inserts 13 are detachably mounted in the mounting slide chutes 14, to form a plurality of independent partition slots.

In the present embodiment, the bait can be placed in the partition slots; and a plurality of inserts 13 can be provided, to divide the interior of the box body 1 into a plurality of partition slots with small spaces, thereby adapting to the storage of bait in small volume.

First limiting strips and second limiting strips are arranged at corresponding positions of the side walls of the partition plates 12 and the inner wall of the box body 1; a gap is formed between each first limiting strip and each second limiting strip, thereby forming the mounting slide chute 14; and both sides of each insert 13 are correspondingly mounted in the mounting slide chute 14 of each partition plate 12 and the mounting slide chute 14 of the box body 1, so that the mounting effect of the insert 13 can be stabilized and the insert 13 can be conveniently disassembled from the mounting slide chute 14.

It should be understood that the inserts 13 are detachably mounted in the mounting slide chutes 14, so that the space size of the partition slots can be adjusted. For example, when the spaces of the partition slots are too small to store large-volume bait, the spaces of the partition slots can be increased by disassembling part of the partition plates 12 or part of the inserts 13, so that the partition slots can adapt to the storage of large-volume bait.

In the present embodiment, the more the partition plates 12 and the inserts 13 are arranged in the box body 1, the more the partition slots are formed by the partition plates 12 and the inserts 13, and correspondingly, the smaller the spaces of the partition slots are. In the present embodiment, two partition plates 12 are preferably arranged in the box body 1; two partition plates 12 are arranged in the box body 1 in parallel and at intervals; and both ends of the partition plates 12 are connected with the inner wall of the box body 1. When the mounting slide chutes 14 are correspondingly arranged between two adjacent partition plates 12, a plurality of inserts 13 are distributed between the two partition plates 12 at intervals to form a plurality of partition slots. When the mounting slide chutes 14 are correspondingly arranged on the side walls of the partition plates 12 and the inner wall of the box body 1, a plurality of inserts 13 are distributed between the partition plates 12 and the inner wall of the box body 1 at intervals to form a plurality of partition slots.

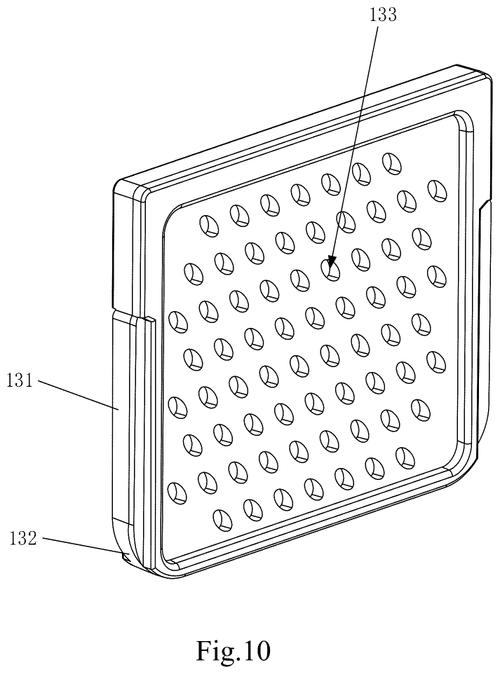

Referring to FIGS. 9 and 10, in one embodiment, clamping strips 131 are arranged at both sides of the inserts 13; notches of the mounting slide chutes 14 are gradually enlarged from outside to inside; and the clamping strips 131 are mounted in the mounting slide chutes 14.

In the present embodiment, the first limiting strips and the second limiting strips are arranged obliquely to each other, so that the notches of the mounting slide chutes 14 are gradually enlarged from outside to inside. Because the notches of the mounting slide chutes 14 are small, when the inserts 13 are mounted in the mounting slide chutes 14, the side walls of the first limiting strips and the second limiting strips located at the notches is capable of being abutted against the clamping strips 131, so that the first limiting strips and the second limiting strips limit the clamping strips 131, to stabilize the mounting effect of the inserts 13.

In one embodiment, a protruding clamping part is arranged on each clamping strip 131.

In the present embodiment, the size of the clamping parts is small; and the clamping parts are arranged at both sides of the clamping strips 131 and at the tops of the clamping strips 131. When the clamping strips 131 are slidably mounted in the mounting slide chutes 14, the side walls of the first limiting strips and the second limiting strips will extrude the clamping parts, thereby increasing the friction between the clamping parts and the first limiting strips and the second limiting strips, and further improving the stability of the inserts 13 mounted in the mounting slide chutes 14.

In one embodiment, a bottom groove 17 communicated with the mounting slide chutes 14 is further formed at the inner bottom of the box body 1; a communication part between each mounting slide chute 14 and the bottom groove 17 is set as an arc groove 171; arc parts 132 adapted to the arc groove 171 are arranged at two side bottoms of the inserts 13; and the bottoms of the inserts 13 are limited in the bottom groove 17.

In the present embodiment, arc parts 132 of the inserts 13 can be adapted and matched with the arc grooves 171 after the inserts 13 are mounted in the mounting slide chutes 14. Compared with the conventional structure that right-angle structures at the bottoms of both sides of each insert 13 are matched with a straight groove, the structure in the present embodiment can reduce the impact force between the inserts 13 and the mounting slide chutes 14 to reduce the wear.

The bottoms of the inserts 13 are limited in the bottom groove 17, so that the bottom groove 17 can further limit the shaking of the inserts 13, thereby improving the mounting stability of the inserts 13.

In one embodiment, a plurality of air holes 133 distributed at intervals are formed in each insert 13.

In the present embodiment, the air holes 133 are provided, to improve the air circulation among the plurality of partition slots, thereby keeping the air inside the box body 1 fresh, and further preventing the bait in the box body 1 from deterioration.

In one embodiment, the waterproof bait box further includes a storage box 15; and two sides of the storage box 15 are detachably mounted in the box body 1.

In the present embodiment, the storage box 15 can be opened or closed; and desiccant or air freshener, preferably desiccant in the present embodiment, can be placed in the storage box 15. The desiccant can absorb moisture, to always keep the interior the box body 1 in a dry environment, and further prevent the bait from deterioration due to exposure to the moisture.

In the present embodiment, the storage box 15 can be set as a mounting structure of the inserts 13, i.e., the clamping strips 131 on the inserts 13 are arranged at two sides of the storage box 15; clamping parts are arranged on the clamping strips 131, so that the storage box 15 can also be mounted in the mounting slide chute 14; and the air holes 133 on the inserts 13 can also be formed in the storage box 15, to keep the air inside the storage box 15 fresh.

In one embodiment, the cover body 2 is made of a transparent material.

In the present embodiment, the interior of the box body 1 can be directly observed from the exterior of the cover body 2 without releasing the locking state between the cover plate and the box body 1 through the locking piece 3; and then the opening of the box body 1 can be opened by the cover body 2, to prevent moisture from entering the box body 1 when the opening of the box body 1 is opened by the cover body 2, thereby not only ensuring the dry environment in the box body 1, but also improving the convenience of observing the interior of the box body 1.

Referring to FIG. 11, in one embodiment, anti-skid stripes 16 and/or anti-skid pads are arranged at the bottom of the box body 1.

In the present embodiment, the anti-skid stripes 16 or the anti-skid pads can prevent the box body 1 from sliding, to improve the stability of the box body 1 on the ground, and then protect the box body 1 from damage.

In one embodiment, a scaleplate is arranged on a surface of the cover body 2.

In the present embodiment, the length of bait can be measured by the scaleplate, to increase the application function of the present embodiment and avoid carrying an additional scaleplate.

The above are only specific embodiments of the present application and not intended for limiting the protection scope of the present application. Any one of those skilled in the art can easily think of various equivalent modifications or substitutions within the technical scope disclosed by the present application; and all the equivalent modifications or substitutions should fall within the protection scope of the present application. Therefore, the protection scope of the present application shall be subject to the protection scope of claims.

What is claimed is:

1. A waterproof bait box, comprising:
a box body provided with an opening at a top;
a cover body rotatably connected with one side of the box body and covering the opening, and
a locking piece comprising a connecting piece and a locking plate, wherein one side of the connecting piece is rotatably connected with one side of the locking plate, the other side of the connecting piece is rotatably connected with the box body; the other side of the locking plate is capable of being connected with the cover body in a buckling manner;
wherein when the other side of the locking plate is connected with the cover body in the buckling manner, one side of the locking plate and one side of the connecting piece can rotate towards the box body and be buckled to lock the box body and the cover body.

2. The waterproof bait box according to claim 1, wherein an abutting part is arranged at one side of the locking plate, and one side of the connecting piece is rotatably connected with the abutting part, when one side of the locking plate and one side of the connecting piece rotate towards the box body and are buckled, the abutting part is capable of being abutted against the box body, so that a space is formed between the locking plate and the box body.

3. The waterproof bait box according to claim 1, wherein the connecting piece comprises a first connecting rod and a second connecting rod, the first connecting rod is connected with the second connecting rod in a radial direction, the first connecting rod is rotatably connected with the locking plate, and the second connecting rod is rotatably connected with the box body.

4. The waterproof bait box according to claim 3, wherein a mounting part is arranged on the box body, a through hole is formed in the mounting part, a mounting port is formed in a side wall of the through hole, and the second connecting rod is extruded and assembled in the through hole through the mounting port and is rotatably arranged.

5. The waterproof bait box according to claim 4, wherein a protruding part is arranged on an inner wall of the through hole, and the second connecting rod is limited in the through hole by the protruding part.

6. The waterproof bait box according to claim 1, wherein a first convex strip is arranged at the other side of the locking plate, a corresponding second convex strip is arranged on the cover body, and the locking plate and the cover body are connected with the second convex strip through the first convex strip in the buckling manner.

7. The waterproof bait box according to claim 6, wherein the side where the first convex strip is buckled with the second convex strip is set as a first inclined surface or a first arc surface; one side of the second convex strip away from the locking plate is set as a second inclined surface opposite to the first inclined surface or a second arc surface opposite to the first arc surface, and the first convex strip and the second convex strip are capable of being buckled with each other through the first inclined surface and the second inclined surface or the first arc surface and the second arc surface.

8. The waterproof bait box according to claim 1, further comprising a sealing piece which is arranged between covering surfaces of the cover body and the box body.

9. The waterproof bait box according to claim 1, wherein a plurality of partition plates and inserts are arranged inside the box body, mounting slide chutes are correspondingly formed in side walls of the partition plates and the inner wall of the box body, and/or mounting slide chutes are correspondingly formed in side walls of adjacent partition plates, and both sides of the inserts are detachably mounted in the mounting slide chutes, to form a plurality of independent partition slots.

10. The waterproof bait box according to claim 9, wherein clamping strips are arranged at both sides of the inserts, notches of the mounting slide chutes are gradually enlarged from outside to inside, and the clamping strips are mounted in the mounting slide chutes.

11. The waterproof bait box according to claim 10, wherein a protruding clamping part is arranged on each clamping strip.

12. The waterproof bait box according to claim 9, wherein a bottom groove communicated with the mounting slide chutes is further formed at the inner bottom of the box body, a communication part between each mounting slide chute and the bottom groove is set as an arc groove, arc parts adapted to the arc groove are arranged at two side bottoms of the inserts, and the bottoms of the inserts are limited in the bottom groove.

13. The waterproof bait box according to claim 9, wherein a plurality of air holes distributed at intervals are formed in the inserts.

14. The waterproof bait box according to claim 9, further comprising a storage box, wherein both sides of the storage box are detachably mounted in the box body.

15. The waterproof bait box according to claim 1, wherein the cover body is made of a transparent material.

16. The waterproof bait box according to claim 1, wherein anti-skid stripes and/or anti-skid pads are arranged at the bottom of the box body.

17. The waterproof bait box according to claim 1, wherein a scaleplate is arranged on a surface of the cover body.
